(19) United States
(12) Patent Application Publication
(10) Pub. No.: US 2019/0040658 A1
(43) Pub. Date: Feb. 7, 2019

(54) DOOR HANDLE DEVICE

(71) Applicant: KABUSHIKI KAISHA TOKAI RIKA DENKI SEISAKUSHO, Aichi (JP)

(72) Inventors: Tatsuya SUZUKI, Aichi (JP); Keishi KANEMATSU, Aichi (JP)

(21) Appl. No.: 16/075,029

(22) PCT Filed: Feb. 6, 2017
(86) PCT No.: PCT/JP2017/004262

§ 371 Date: Aug. 2, 2018

(30) Foreign Application Priority Data
Feb. 12, 2016 (JP) 2016-025035

(51) Int. Cl. E05B 81/76; E05B 85/12

(52) U.S. Cl. CPC E05B 81/76; E05Y 2400/86; E05Y 2900/531; E05B 85/12

(57) ABSTRACT

A door handle device includes a resin panel fixed to a vehicle door, and a handle lever rotatably supported on the resin panel via a rotation support. The rotation support includes a conductive part configured to form an electrostatic capacitance between the conductive part and a finger operating the handle lever.

### TECHNICAL FIELD

The present invention relates to door handle devices, and in particular, relates to door handle devices applied to handle levers operated when releasing door locks from inside vehicles.

### BACKGROUND ART

As an example of a configuration for releasing a door lock from inside a vehicle, a vehicle door lock system capable of releasing a door lock by bringing a finger into contact with or close to a back surface of an inside handle lever attached on an inner side of a door via a rotating shaft extending substantially vertically is disclosed (for example, see Patent Document 1).

The vehicle door lock system described in Patent Document 1 releases the door lock using a touch sensor (such as an electrostatic capacitive touch sensor) provided on the back surface of the inside handle lever to detect contact or approach of a finger or using the inside handle lever of which rotation is transmitted to a lock mechanism as rectilinear motion via a transmission cable.

The touch sensor outputs an electric signal indicating that contact or approach of a finger is detected to a controller through electric wires. The lock mechanism includes a driving source that drives an engaging member engageable with and disengageable from a striker attached to a vehicle body, and the driving source drives the engaging member in a disengaging direction to release the door lock when the driving source receives a driving signal output from the controller based on the electric signal of the touch sensor.

### CITATION LIST

### Patent Literature

Patent Document 1: JP 2014-227760A

### SUMMARY OF INVENTION

### Technical Problem

In the vehicle door lock system described in Patent Document 1, the electric wires connected to the touch sensor extend through the inside of the inside handle lever and is drawn out to the outside of the handle lever. This causes an extra space for routing the electric wires to be left in the inside handle lever in consideration of the rotation of the inside handle lever.

An object of the invention is to provide a door handle device eliminating a need for a space for routing electric wires in an inside handle lever.

### Solution to Problem

According to an aspect of the invention, a door handle device includes a resin panel fixed to a vehicle door and a handle lever rotatably supported on the resin panel via a rotation support. The rotation support includes a conductive part configured to form an electrostatic capacitance between the conductive part and a finger operating the handle lever.

In the door handle device described above, the rotation support may include a support receiving portion disposed on the resin panel and a support portion disposed on the handle lever and rotatably supported by the support receiving portion, and the conductive part may include a first electrode disposed on the support receiving portion and a second electrode disposed on the support portion.

In the door handle device described above, the second electrode may be connected with the first electrode to be rotatable while in contact with the first electrode, and the first electrode may be connected with an electric wire electrically connected to an outside component.

In the door handle device described above, the support receiving portion may include a first connector fit into and connected with the support portion.

In the door handle device described above, the door handle device may further include a second connector connected with the first connector, and the second connector may be connected with an electric wire electrically connected to an outside component. In the door handle device described above, the support receiving portion may be unrotatably fixed to the resin panel, and the first electrode of the support receiving portion may be connected with an electric wire electrically connected to an outside component. In the door handle device described above, the handle lever may include an insulator and a metal coating layer formed on a surface of the insulator.

### Advantageous Effects of Invention

According to an aspect of the invention, a door handle device eliminating the need for a space for routing electric wires in an inside handle lever is provided.

### BRIEF DESCRIPTION OF DRAWINGS

FIG. 1 is a perspective view illustrating a vehicle door including a door handle device according to a first embodiment of the invention.

FIG. 2 is a front view illustrating an inside handle lever applied to the door handle device according to the first embodiment.

FIG. 3 is an enlarged sectional view illustrating main components of the inside handle lever applied to the door handle device according to the first embodiment.

FIG. 4 is an enlarged sectional view illustrating main components of an inside handle lever applied to a door handle device according to a second embodiment of the invention.

### DESCRIPTION OF EMBODIMENT

Preferred embodiments of the invention will be described in detail hereinafter with reference to the appended drawings.

### First Embodiment

### Overall Configuration of Driver's Door in Vehicle

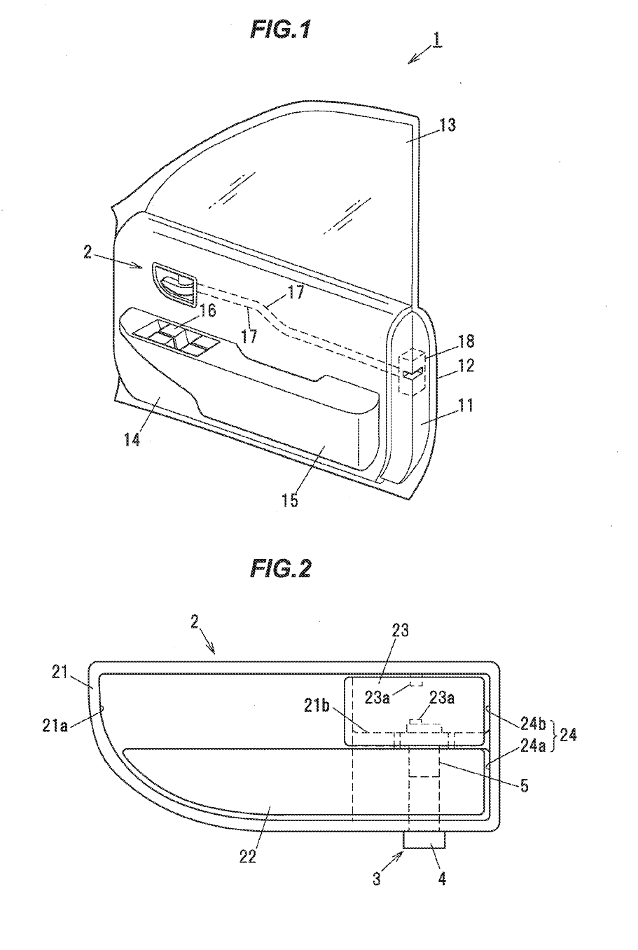

In FIG. 1, reference numeral 1 indicating the whole schematically denotes an example of a driver's door in a vehicle. The driver's door 1 includes an inner panel 11 and an outer panel 12. A window glass 13 capable of being lifted and lowered is installed between the inner panel 11 and outer panel 12.

A door trim 14 is attached to the inner panel 11, and an inner door handle (inside handle) device 2 to be operated when releasing a door lock from inside a vehicle cabin is attached to the inner panel 11 through an opening formed in the door trim 14. A door armrest 15 protruding toward the vehicle cabin is attached to the door trim 14, and a power window switch 16 is installed in the top surface of the door armrest 15.

### Configuration of Door Handle Device

As illustrated in FIGS. 1 and 2, the inner door handle device 2 (hereinafter referred to as door handle device 2) includes an insulating resin panel 21 fastened to the inner panel 11 by screwing. An inside handle lever 22 configured to open and close the driver's door 1 and a lock knob 23 configured to prevent the inside handle lever 22 from releasing the door lock are disposed in the resin panel 21.

The resin panel 21 includes a hollowed operating portion 21a having a curved surface and protruding toward the outer panel 12 of the driver's door 1 frontward in the longitudinal direction of the vehicle. A shaft hole 24 passes through the resin panel 21 backward in the longitudinal direction of the vehicle. The shaft hole 24 is sectioned into two, a lever shaft hole 24a and a knob shaft hole 24b, in the vertical direction of the vehicle by a support beam 21b extending in the longitudinal direction of the vehicle.

The inside handle lever 22 is rotatably supported by a rotation support 3 between the support beam 21b and an opening end face of the resin panel 21 adjacent to the level shaft hole 24a. Shaft portions 23a, 23a configured to rotatably support the lock knob 23 protrude on an identical axis between the support beam 21b and an opening end face of the resin panel 21 adjacent to the knob shaft hole 24b.

As illustrated in FIG. 2, the shaft portions 23a for the lock knob 23 are disposed in the vertical direction of the vehicle closer to the front of the vehicle and to the outer panel 12 than the rotation support 3 for the inside handle lever 22 is.

The inside handle lever 22 and the lock knob 23 are formed of an insulator such as synthetic resin, and a metal coating layer is applied to the surface of the insulator. The metal coating layer is formed by, for example, metal plating or metal deposition using tin, nickel, or the like.

A torsion spring (not illustrated) is interposed in the inside handle lever 22. When rotated, the inside handle lever 22 is configured to return to an initial stop position by the force of the torsion spring.

The inside handle lever 22 and the lock knob 23 are connected to a door lock device 18 installed in the driver's door 1 via respective connecting cables 17, 17. The door lock device 18 includes a latch mechanism (not illustrated) that is engageable with and disengageable from a striker secured to the vehicle body and a lock mechanism (not illustrated) that switches between a lock position at which the latch mechanism is not disengageable and an unlock position at which the latch mechanism is disengageable.

When the door lock device 18 is at the lock position, rotation of the lock knob 23 switches the lock mechanism from the lock position to the unlock position via the connecting cable 17, and the door lock device 18 is kept in the unlock state.

On the other hand, when the lock knob 23 is at the unlock position, rotation of the inside handle lever 22 releases the lock state of the door lock device 18 via the connecting cable 17 to open the driver's door 1. When the lock knob 23 is at the lock position, rotation of the inside handle lever 22 is disabled, and the door lock device 18 is maintained.

### Configuration of Rotation Support

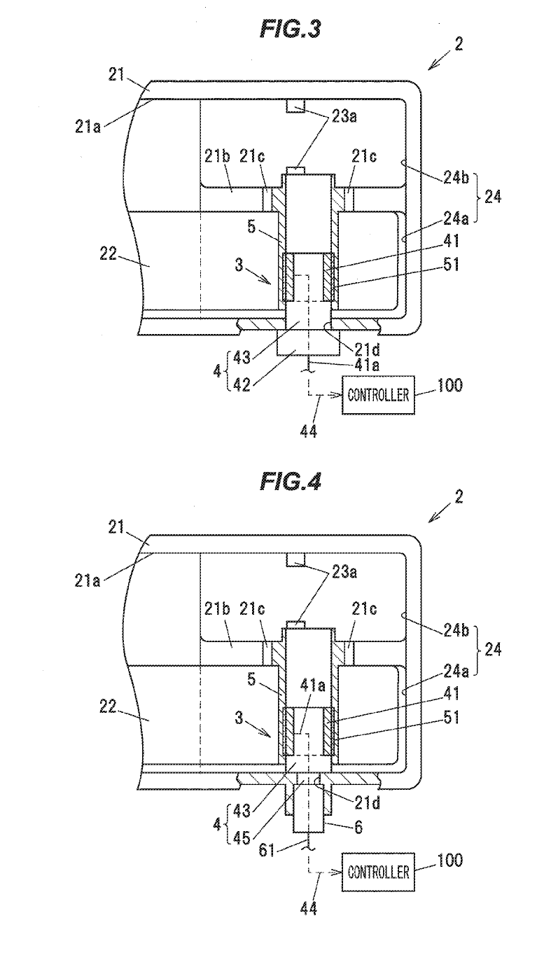

As illustrated in FIGS. 2 and 3, the rotation support 3 supporting the inside handle lever 22 on the resin panel 21 to be rotatable includes a support receiving portion 4 having a column shape and a support portion 5 having a cylindrical shape rotatably supported by the support receiving portion 4. The support receiving portion 4 is disposed on the resin panel 21 not to be rotatable on the rotational axis of the inside handle lever 22. On the other hand, the support portion 5 is disposed in the inside handle lever 22.

As illustrated in FIGS. 2 and 3, an upper portion of the support portion 5 in the vertical direction of the vehicle is snap-fit between a pair of engaging pieces 21c, 21c protruding from the support beam 21b of the resin panel 21, and a lower portion of the support portion 5 in the vertical direction of the vehicle is fit onto the support receiving portion 4 on the resin panel 21. This enables the inside handle lever 22 to be rotatably supported on the resin panel 21.

The door handle device 2 of this type may allow an operator to control operations of predetermined vehicle-mounted devices as intended when the finger of the operator come into contact with the inside handle lever 22. Examples of the operation control include, for example, releasing door locks, retracting door mirrors, switching dome lights on, and closing power windows.

One of the major features of the door handle device 2 of the invention is that the rotation support 3 supporting the inside handle lever 22 on the resin panel 21 to be rotatable is electrically conductive. This enables presence of changes in the electrostatic capacitance between the inside handle lever 22 and the finger in contact to be detected without directly connecting an electric wire 44 with the rotating portion of the inside handle lever 22, and thus enables the operations of the predetermined vehicle-mounted devices to be controlled.

As illustrated in FIGS. 2 and 3, first and second conductive members are respectively embedded in the support receiving portion 4 on the resin panel 21 and the support portion 5 in the inside handle lever 22 to form an electrostatic capacitance when a finger of an operator come into contact with the inside handle lever 22.

A connection electrode 41 serving as a first electrode embedded along the circumferential surface of the support receiving portion 4 constitutes the first conductive member of the support receiving portion 4, and correspondingly, a detection electrode 51 serving as a second electrode formed along the circumferential surface of the support portion 5 constitutes the second conductive member of the support portion 5.

The support receiving portion 4 on the resin panel 21 may be a plug connector serving as a first connector having a shape that can be fit into the support portion 5 supporting the inside handle lever 22 on the resin panel 21 to be rotatable.

As illustrated in FIG. 3, the support receiving portion 4 constituting the connector includes an attachment part 42 composed of an insulating resin and unrotatably caught in and fixed around the periphery of a lower part, in the vertical direction of the vehicle, of an opening of a fixing hole 21d bored in the resin panel 21, and a fit connecting part 43 composed of an insulating resin and having an outer shape fit into and connected with the support portion 5 in the inside handle lever 22. The connection electrode 41 composed of metal such as gold, silver, copper, or aluminum is embedded in the fit connecting part 43.

On the other hand, the support portion 5 in the inside handle lever 22 is fit onto the fit connecting part 43 of the support receiving portion 4 constituting the connector. The detection electrode 51 composed of metal such as gold, silver, copper, or aluminum is embedded in the support portion 5. The detection electrode 51 is disposed to be rotatable while in contact with the connection electrode 41 that transmits a detection signal, and is electrically connected with the connection electrode 41.

The vehicle body is provided with a controller 100 configured to detect presence of changes in the electrostatic capacitance value of the detection electrode 51. A terminal 41a of the connection electrode 41 in the support receiving portion 4 on the resin panel 21 is connected with the electric wire 44 to be electrically connected to the controller 100.

When a finger of the operator come into contact with the inside handle lever 22, an electrostatic bond is formed between the finger and the detection electrode 51 (that is, the inside handle lever 22 and the detection electrode 51 constitute an electrostatic capacitive touch sensor). Contact of the finger of the operator with the inside handle lever 22 causes changes in the electrostatic capacitance value of the detection electrode 51, and a detection signal indicating the electrostatic capacitance value is output from the terminal 41a of the connection electrode 41 adjacent to the resin panel 21 to the controller 100 via the electric wire 44.

The controller 100 is a microcomputer including various components such as a CPU that performs calculation and processing on acquired data based on stored programs and a RAM and a ROM serving as semiconductor memories.

The controller 100 determines whether a finger is brought into contact with the inside handle lever 22 based on the change in the electrostatic capacitance value detected by the detection electrode 51, and outputs operation control signals to predetermined vehicle-mounted devices when it is determined that a finger is brought into contact with the inside handle lever 22.

The positions, forms, and the like of the connection electrode 41 and the detection electrode 51 are not particularly limited, and may be selected as appropriate to detect changes in the electrostatic capacitance value of the detection electrode 51. The shapes or materials of the connection electrode 41 and the detection electrode 51 are also not particularly limited, and conductive resin, for example, may be formed on the circumferential surfaces of the support receiving portion 4 and the support portion 5.

In the first embodiment, the support receiving portion 4 on the resin panel 21 is a plug connector fit into and connected with the support portion 5 in the inside handle lever 22. However, the support receiving portion 4 on the resin panel 21 may be a receptacle connector fit onto and connected with the outer circumferential surface of the support portion 5 in the inside handle lever 22.

Moreover, in the first embodiment, the support receiving portion 4 is a connector. However, the support receiving portion 4 may have a configuration other than the example illustrated in the drawings as long as the rotation support 3 supporting the inside handle lever 22 on the resin panel 21 to be rotatable is electrically conductive.

As another example of the rotation support 3, for example, the connection electrode 41 may be embedded in a boss portion having a column shape integrated with and protruding from the fixing hole 21d of the resin panel 21 instead of the support receiving portion 4.

As yet another example of the rotation support 3, for example, the detection electrode 51 may be embedded in a support portion having a column shape instead of the support portion 5, and a boss portion having a cylindrical shape in which the connection electrode 41 is embedded may be fit onto and connected with the support portion having a column shape.

### Effects of First Embodiment

According to the door handle device 2 in the first embodiment having the above-described configuration, the rotation support 3 supporting the inside handle lever 22 on the resin panel 21 to be rotatable is electrically conductive. This results in the following effects in addition to the effects described above.

Since the electric wire 44 is not directly connected to the inside handle lever 22 to be rotated, the electric wire 44 is not twisted or bent along with the rotation of the inside handle lever 22. This improves the reliability and the durability of the electric wire 44.

Since the electric wire 44 is not directly connected to the inside handle lever 22 to be rotated, no extra length needs to be allocated to the electric wire 44 during designing. As a result, the routing length of the electric wire 44 decreases, and the routing space for the electric wire 44 also decreases.

Since no electric wire 44 is directly connected to the detection electrode 51 that rotates along with the rotation of the inside handle lever 22, the rotation operability of the inside handle lever 22 is improved.

### Second Embodiment

Herein, description will be given with reference to FIG. 4. FIG. 4 schematically illustrates an example of the inside handle lever 22 in the door handle device 2 according to a second embodiment.

The configuration in the second embodiment is substantially identical to the configuration in the first embodiment except the configuration of the rotation support 3 supporting the inside handle lever 22 on the resin panel 21 to be rotatable. Therefore, reference signs identical to the reference signs used in the first embodiment are used, and detailed descriptions of the components with the reference signs will be omitted.

The second embodiment differs from the first embodiment in that the support receiving portion 4 of the rotation support 3 at the inside handle lever 22 includes two connector connecting parts and that the rotation support 3 includes a second connector 6 fit onto and connected with the support receiving portion 4.

As illustrated in FIG. 4, the support receiving portion 4 on the resin panel 21 includes two connecting parts having shapes that can fit into and connect with the support portion 5 in the inside handle lever 22 and the connector 6. The fit connecting part 43 has an outer shape that fits into the support portion 5, and the connector connecting part 45 has an outer shape that fits into the connector 6 via the fixing hole 21d of the resin panel 21.

The fit connecting part 43 of the support receiving portion 4 serves as a bearing part having a column shape supporting the inside handle lever 22 on the resin panel 21 to be rotatable, and is unrotatably caught in and fixed around the periphery of an upper part, in the vertical direction of the vehicle, of the opening of the fixing hole 21d of the resin panel 21. The connection electrode 41 is embedded in the circumferential surface of the fit connecting part 43, and the connection electrode 41 is electrically connected to the detection electrode 51 embedded in the circumferential surface of the support portion 5 in the inside handle lever 22.

In the illustrated example, the connector 6 fit onto and connected with the connector connecting part 45 of the support receiving portion 4 is a receptacle connector, and includes a terminal 61 serving as an electrode connected to the terminal 41a of the connection electrode 41 on the support receiving portion 4.

The terminal 61 of the connector 6 is connected with the electric wire 44 configured to transmit a detection signal from the detection electrode 51 to the controller 100. The detection electrode 51 forms an electrostatic capacitance between the detection electrode 51 and the finger of the operator that operates the inside handle lever 22, and the detection signal indicating the electrostatic capacitance value is output from the terminal 61 of the connector 6 connected with the terminal 41a of the connection electrode 41 on the support receiving portion 4 to the controller 100 via the electric wire 44.

Also in the second embodiment, for example, the support receiving portion 4 constituting the first connector may be a receptacle connector while the second connector 6 may be a plug connector as long as the rotation support 3 supporting the inside handle lever 22 on the resin panel 21 to be rotatable is electrically conductive.

### Effects of Second Embodiment

The door handle device 2 according to the second embodiment having the above-described configuration yields the following effects in addition to the effects similar to the first embodiment.

The connector 6 fit onto and connected with the support receiving portion 4 supporting the inside handle lever 22 to be rotatable increases flexibility in routing of the electric wire 44.

### Modification

The following modification is applicable to the above-described embodiments.

The installation position of the door handle device 2 is not particularly limited. For example, the door handle device 2 is applicable to door handle devices attached to door trims on the passenger's door, the right rear door, and the left rear door other than the driver's door 1.

The configuration of the door handle device 2 including the inside handle lever 22 is illustrated in the first and second embodiments above. However, the invention is not limited to the above-described embodiments, and is applicable to door handle devices including an outside handle lever depending on the intended use.

The door handle device 2 for a vehicle is illustrated in the above-described embodiments. However, the embodiment is not limited to the door handle device 2 for a vehicle, and is applicable to, for example, doors for residential buildings and any other objects that open and close.

As is clear from the explanation above, the door handle device 2 of the invention described based on the embodiments, the modification, and the illustrated examples above is not limited to the embodiments, the modification, and the illustrated examples above, and can be carried out in various modes within the scope of the invention.

As such, it should be understood that all combinations of the features described in the embodiments, the modification, and the illustrated examples above are not required parts of the means to solve the problems of the invention.

### REFERENCE SIGNS LIST

1 Driver's door
2 Inner door handle device
3 Rotation support
4 Support receiving portion (first connector)
5 Support portion
6 Second connector
21 Resin panel
22 Inside handle lever
41 Connection electrode (first electrode)
44 Electric wire
51 Detection electrode (second electrode)

1. A door handle device, comprising: a resin panel fixed to a vehicle door; and a handle lever rotatably supported on the resin panel via a rotation support, wherein the rotation support comprises a conductive part configured to form an electrostatic capacitance between the conductive part and a finger operating the handle lever.

2. The door handle device according to claim 1, wherein the rotation support, comprises a support receiving portion disposed on the resin panel and a support portion disposed on the handle lever and rotatably supported by the support receiving portion, and wherein the conductive part comprises a first electrode disposed on the support receiving portion and a second electrode disposed on the support portion.

3. The door handle device according to claim 2, wherein the second electrode is connected with the first electrode to be rotatable while contacting with the first electrode, and wherein the first electrode is connected with an electric wire electrically connected to an outside component.

4. The door handle device according to claim 2, wherein the support receiving portion comprises a first connector fit into and connected with the support portion.

5. The door handle device according to claim 4, further comprising a second connector connected with the first connector, wherein the connected to an outside component.

6. The door handle device according to claim 2, wherein the support receiving portion is unrotatably fixed to the resin panel, and wherein the first electrode of the support receiving portion is connected with an electric wire electrically connected to an outside component.

7. The door handle device according to claim 1, wherein the handle lever comprises an insulator and a metal coating layer formed on a surface of the insulator.
